(19) United States
(12) Patent Application Publication
(10) Pub. No.: US 2023/0028886 A1
(43) Pub. Date: Jan. 26, 2023

(54) METHODS OF DETECTING ANOMALOUS OPERATION OF INDUSTRIAL SYSTEMS AND RESPECTIVE CONTROL SYSTEMS, AND RELATED SYSTEMS AND ARTICLES OF MANUFACTURE

(71) Applicant: University of Tennessee Research Foundation, Knoxville, TN (US)

(72) Inventors: Fan Zhang, Knoxville, TN (US); Jamie Baalis Coble, Knoxville, TN (US)

(21) Appl. No.: 17/756,252

(22) PCT Filed: Nov. 20, 2020
(86) PCT No.: PCT/US2020/061453

§ 371 Date: May 19, 2022

Related U.S. Application Data
(60) Provisional application No. 62/937,882, filed on Nov. 20, 2019.

(51) Int. Cl. G05B 23/02

(52) U.S. Cl. CPC G05B 23/0259

(57) ABSTRACT

A method of detecting an operational anomaly of an industrial system can include receiving operational values for a plurality of process parameters from an industrial system at a localized anomaly detection system, wherein the plurality of process parameters, accessing a machine learning model stored in a non-volatile memory system operating within the localized anomaly detection system, to determine predicted values for the process parameters based on the operational values of the process parameters received from the industrial system, and determining residual values for the process parameters, each representing a difference between a respective one of the predicted values and a respective one of the operational values.

### CROSS-REFERENCE TO RELATED APPLICATIONS

This application claims priority to U.S. Provisional Patent Application No. 62/937,882, titled Robust Localized Cyber-Attack Detection for Key Equipment In Nuclear Power Plants, filed Nov. 20, 2019, in the U.S.P.T.O., the entire disclosure of which is incorporated herein by reference.

### STATEMENT OF GOVERNMENT SUPPORT

This work was supported by a Nuclear Energy University Programs (NEUP) grant sponsored by the U.S. Department of Energy, Office of Nuclear Energy, award number DE-NE0008898. The government has certain rights in the invention.

### FIELD

The invention relates to the field of control systems, and more particularly, to security for control systems.

### BACKGROUND

Industrial control systems (ICS) are utilized in various industries, such as electricity generation and distribution, water distribution, oil and natural gas, transportation, and chemical production, for high-value and safety-critical systems. Control systems are utilized to carry out operations of these systems and the sub-systems that make up those systems. For example, Programmable Logic Controllers (PLC) are widely utilized in ICSs as part of the control systems automation for Nuclear Power Plants (NPP), which can operate for extended periods of time without the need for major maintenance.

These control systems, however, do not generally operate under traditional authentication and encryption techniques given the real-time nature of many of the processes performed. Accordingly, ICS s may be susceptible to electronic attacks (sometimes referred to herein as cyber-attacks). For example, some PLCs have been demonstrated as vulnerable to potential cyber-attacks via injection of malicious code into a PC from a PLC without interfering with the PLC's operation. Moreover, even more “secure” version, such as the version S7 protocol, has been shown to be vulnerable to cyber-attacks

A PLC may be vulnerable to several type of cyber-attacks including a) Denial of service (DoS) attacks to stop or slow down the PLC control; b) malicious control logic injection to alter PLC control, which can cause a change of the control logic executing on the PLC; and c) man-in-the-middle (MITM) attacks to the input of the PLC which can cause the PLC to issue commands that are not called for by the correct control logic. Although defenses to these types of attacks on PLC-based control systems have been developed, those defenses have fallen-short of offering broad protection.

### SUMMARY

Embodiments according to the present invention can provide methods of electronically protecting industrial systems from attack on, or anomalous operation of, respective control systems, related systems and articles of manufacture. Pursuant to these embodiments, in some embodiments according to the invention, a method of detecting an operational anomaly of an industrial system can include receiving operational values for a plurality of process parameters from an industrial system at a localized anomaly detection system, wherein the plurality of process parameters, accessing a machine learning model stored in a non-volatile memory system operating within the localized anomaly detection system, to determine predicted values for the process parameters based on the operational values of the process parameters received from the industrial system, and determining residual values for the process parameters, each representing a difference between a respective one of the predicted values and a respective one of the operational values.

In some embodiments according to the invention, a method of detecting an operational anomaly of a Programmable Logic Controller (PLC) system can include receiving, at a localized anomaly detection system, operational values for a plurality of process parameters from data blocks in a CPU runtime of the PLC system, accessing a machine learning model stored in a non-volatile memory system operating within the localized anomaly detection system, to determine predicted values for the process parameters based on the operational values of the process parameters received from the PLC system, and determining residual values for the process parameters, each representing a difference between a respective one of the predicted values and a respective one of the operational values.

In some embodiments according to the invention, a localized anomaly detection system can include a processor circuit configured to receive operational values for a plurality of process parameters from a single sub-system included in an industrial system, to monitor the single sub-system for anomalous activity, a non-volatile memory storing a machine learning model configured to determine predicted values for the process parameters based on the operational values of the process parameters received from the single sub-system, a memory operatively coupled to the processor circuit, the memory configured to store instructions to execute on the processor circuit to access the machine learning model stored in the non-volatile memory to determine the predicted values for the process parameters based on the operational values of the process parameters received from the single sub-system and determine residual values for the process parameters, each representing a difference between a respective one of the predicted values and a respective one of the operational values.

In some embodiments according to the invention, a method of detecting an operational anomaly of an industrial system can include receiving operational values for a plurality of process parameters from an industrial system at a localized anomaly detection system, accessing a machine learning model stored in a non-volatile memory system operating within the localized anomaly detection system, to determine predicted values for the process parameters based on the operational values of the process parameters received from the industrial system, determining residual values for the process parameters, each representing a difference between a respective one of the predicted values and a respective one of the operational values, and generating a replacement command to the industrial system based on the predicted values responsive to a comparison of respective ones of the residual values to respective ones of threshold values for the residual values.

### BRIEF DESCRIPTION OF THE DRAWINGS

FIG. 1 is a performance curve for an industrial system during normal operation and after initiation of a cyber-attack.

FIG. 2 is a graphical illustration of a simple threshold detection approach for normal operational ranges of system parameters for operation of an example industrial system.

FIG. 3 is a block diagram illustrating nuclear power plant including a steam generator system as an example of an industrial system operatively coupled to a local anomaly detection system configured to detect anomalous operation of the industrial system in some embodiments according to the invention.

FIG. 4 is a block diagram illustrating an industrial system coupled to a separate local anomaly detection system configured to monitor the industrial system in some embodiments according to the invention.

FIG. 5 is a block diagram illustrating a Siemens S7-1518 MFP PLC programmable logic controller (PLC) environment that was implemented to provide a CPU runtime environment to operate an industrial system using process parameters of the process controlled by the industrial system being monitored for anomalous operation by the local anomaly detection system 105 implemented using the PLC system in some embodiments according to the invention.

FIG. 6 is a schematic illustration of a testbed used to evaluate the local anomaly detection system shown in FIG. 5 in some embodiments according to the invention.

FIG. 7 is a screenshot showing an open development kit display of results of an evaluation of the local anomaly detection system shown in FIG. 5 under a scenario where an attacker alters the PLC control logic without the plant operators noticing, by displaying the correct logic to the operator utilizing stealth program injection in some embodiments according to the invention.

FIG. 8 shows steam generator pressure data for the local anomaly detection system shown in FIG. 5 in an attack scenario where the water level of the steam generator as a measurement input to the PLC was altered to 15.9 m constantly but having the water level values shown to the operator as normal (15 m) in some embodiments according to the invention.

FIG. 9 shows steam generator inlet flow rate data for the local anomaly detection system shown in FIG. 5, where malicious code added 0.9 m to the actual steam generator water level measurement at the input of the PLC, which alters the input of the PI controller to X+0.9 m (X being the actual SG water level measurement) in some embodiments according to the invention.

FIG. 10 shows steam generator water level data for the local anomaly detection system shown in FIG. 5, where malicious code altered the water level set point to the PLC to 14 m which was also masked in some embodiments according to the invention.

FIG. 11 is a flowchart illustrating operations of a local anomaly detection system configured to detect anomalous operation of, or attack on, an industrial system using a machine learning model implemented using an auto-associative kernel regression approach to raise an alarm and to alternatively intervene in the control of the industrial system being monitored By generating a replacement command using an inference model based on the predicted values provided by the machine learning model in some embodiments according to the invention.

FIG. 12 shows steam generator water level data including compromised water level, actual water level extracted from the Asherah model, and predicted results in the scenario illustrated in FIG. 8 for the local anomaly detection system shown in FIG. 5 where an attacker alters the water level measurement input to PLC in some embodiments according to the invention.

### DETAILED DESCRIPTION OF EMBODIMENTS ACCORDING TO THE INVENTION

The invention now will be described more fully hereinafter with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As appreciated by the present inventors, a local anomaly detection system can be used to monitor an industrial system for anonymous operation or an attack by obtaining values for parameters that are associated with the system's operations used to control a process. The operational values of the parameters can be, for example, the values of control signals (sometimes referred to as control sensors) that are used by the system to control the process. The operational values can also include that value of indicator sensors (sometimes referred to as indicator signals) that indicate measurements taken on the process that is controlled by the system. A machine learning model can be used to determine predicted values for the system's operation based on the operational values provided (e.g., the control sensor values and/or the indicator signal values). The predicted values can be compared to the operational values to determine residual values that can represent whether the difference indicates that the system is exhibiting anomalous operation (whether resulting from a defect or an attack). In some embodiments according to the invention, the residual values can be compared to respective threshold values to determine whether an alarm should be raised regarding the anomalous operation.

In some embodiments, at least one of the parameters can be a parameter that is subject to control by the process being monitored by the local anomaly detection system. For example, in some embodiments, the industrial system under monitoring can be a programmable logic controller (PLC) configured to control operation of a steam generator in a nuclear power plant using a water level of the steam generator. Accordingly, the control sensor for the water level of the steam generator can be the parameter that is subject to control by the PLC as part of the process. It will be understood, however, that other parameters can be subject to control. Still further the respective residual value that is used to determine whether to raise an alarm can be a residual value for the parameter that is subject to control.

It will be understood that the industrial system can be any system (or portion of a system) that controls an industrial process such a programmable logic controller (PLC) or other processor based system that can operate in real-time to receive the process parameters and take action (or direct an auxiliary system to take action) to operate the industrial process within specified operating conditions. Accordingly, the industrial system can be any application that utilizes a industrial process to operate infrastructure such as power distribution, traffic control, water distribution and/or treatment, air traffic control, communications systems, emergency systems and services, satellite operations, or UPS systems. Other industrial system applications can also be included.

In further embodiments according to the present invention, the parameter that is subject to control can represent a critical parameter relative to other parameters. For example, in the above example, the water level parameter can be designated as a critical parameter that is likely to be the target of an attack. Accordingly, the water level can be included in the operating parameters that are used by the machine learning mode to increase the likelihood of the local anomaly detection system detecting the attack.

In some embodiments according to the invention, the local anomaly detection system can be co-located with the industrial system being monitored so that the exposure of the industrial system to an attack can be reduced (sometimes referred to herein as the industrial system having a reduced attack surface). In such an approach, the local anomaly detection system can be located within the industrial system that is being monitored so that relatively few access points are available to the attack. For example, in some embodiments, the local anomaly detection system can be located on the same board or inside the same enclosure with the industrial system. In some embodiments, the local anomaly detection system can share resources with the industrial system, such as power, memory, processing circuits and the like. For example, in some embodiments the local anomaly detection system can access the operating values of the process parameters via the CPU runtime of the PLC, which may be provided by an executable supported by the PLC itself as described herein.

In still other embodiments, the local anomaly detection system can access the industrial system via a network connection which may be configured so that the local anomaly detection system communicates with the industrial system over a secure channel. In still other embodiments, the local anomaly detection system can access the industrial system via a dedicated network connection.

In still other embodiments, the local anomaly detection system is configured to monitor only a particular industrial system whereas other local anomaly detection systems are configured to monitor other respective industrial systems. Accordingly, in such embodiments, the industrial system can be a sub-system in a larger industrial system. For example, the steam generator described above can therefore be a single sub-system of the nuclear power plant that is monitored by a respective local anomaly detection system whereas other sub-systems of the plant may be monitored by other local anomaly detection systems. As appreciated by the present inventors, this approach may provide quicker detection of an anomaly, such as an attack, as each of the local anomaly detection systems handles a single sub-system thereby providing a lesser attack surface. In contrast to this bottom-up type approach, top-down approaches may aggregate data at a higher level, whereby each level of hierarchy can increase the attack surface.

In still other embodiments according to the present invention, the machine learning model can be stored in a non-volatile memory that is operatively coupled to a processor circuit that performs operations of the local anomaly detection system. Accordingly, the machine learning model can be programmed to the non-volatile memory so that the model is available to the local anomaly detection system without relying on outside resources, such as a cloud based storage system of other type of distributed memory system which may be commonly used by large machine learning models. In some embodiments according to the present invention, the machine learning model can be a static model that is programed to the non-volatile memory for use but may be re-trained and re-programmed to the non-volatile memory to, for example, update the model. In some embodiments according to the invention, the machine learning model can be compact so that the entire model may be stored in the non-volatile memory. In some embodiments, the machine learning model can be trained using data collected from a plurality of other industrial systems which can then be updated to one or more local anomaly detection systems.

In some embodiments according to the present invention, the machine learning model can be provided by any compact machine learning model implementation using for example the following approaches auto-associative kernel regression, artificial or deep neural networks, decision trees, K nearest neighbor, ensemble learning, bagging, random forest and the like. Other approaches may also be used separately or in combination with those listed.

Still further, in some embodiments, a plurality of machine learning models may be used by the local anomaly detection systems to detect anomalous operation of the industrial system by implementing a voting scheme whereby a number of the models may operate on the process parameters. Accordingly, respective determinations may be provided by the different models which may in-turn be combined in the voting system to provide an overall determination. In some embodiments, each determination may have a respective weighting factor in the combined determination. Other approaches can also be used in the voting systems in embodiments according to the invention.

In still further embodiments, an inference model can be used to determine whether the local anomaly detection system should intervene and assume control of the process from the industrial system. For example, in some embodiments according to the invention, a replacement value for a particular parameter can be provided using an inference model based on the predicted values. For example, if the residual values vary to a particular level relative to the threshold values, the replacement value can be generated based on the predicted values that were generated from the operational values provided to the machine learning model. Further, the replacement value can be mapped to a replacement command that can be issued to the industrial system. Still further in some embodiments, the replacement command can be a command that is configured to place the industrial system in a known state, such as a shut down. In some embodiments, the replacement command can be a command that is configured to transfer control of the industrial system to an alternative industrial system that, for example, has resource independent of the industrial system exhibiting the anomalous operation.

As appreciated by the present inventor, PLCs have been the target of particular cyber-attacks and additional vulnerabilities in PLCs have been revealed that may offer opportunities for potential cyber-attacks, such using as attack to capture a single authentication packet to reverse engineer the password of a PLC. It has also been shown that a PLC worm can spread internally without triggering the alarms of standard antivirus products since the PLC may not use a standard computer. Moreover, it has been shown that an attack can inject malicious code into a PC from a PLC without interfering with the operation of the PLC, which can use trusted systems into potential attack vectors.

FIG. 1 is a performance curve for an industrial system during normal operation and after initiation of a cyber-attack. According to FIG. 1, before the cyber-attack, the process performs at best performance under normal operation. After an attack, the initial impact of the performance is relatively low, with the rate of performance reduction increasing as time goes on due to the chain consequences of the whole system. As appreciated by the present inventor, an early detection of the cyber-attack in the early stages of the curve could provide precious time for defenders to take action and prevent significant consequences such as component failure by pushing the detection point in FIG. 1 as much as possible to the left.

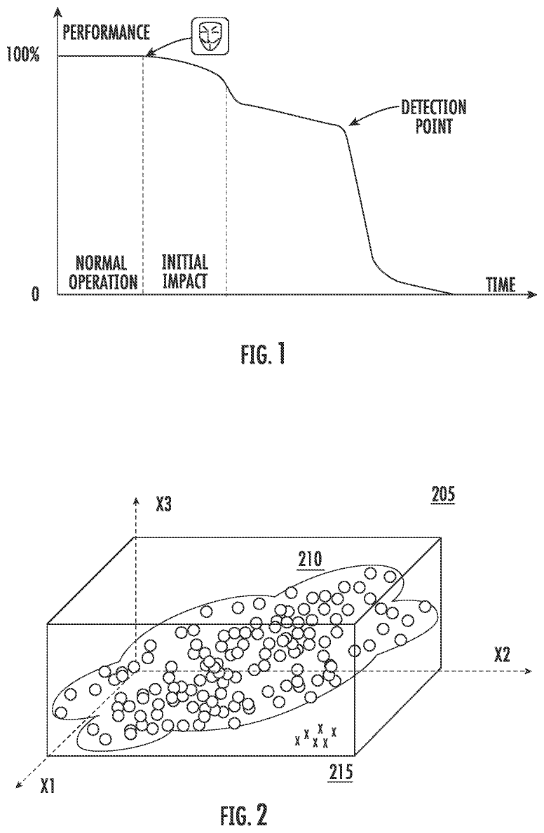

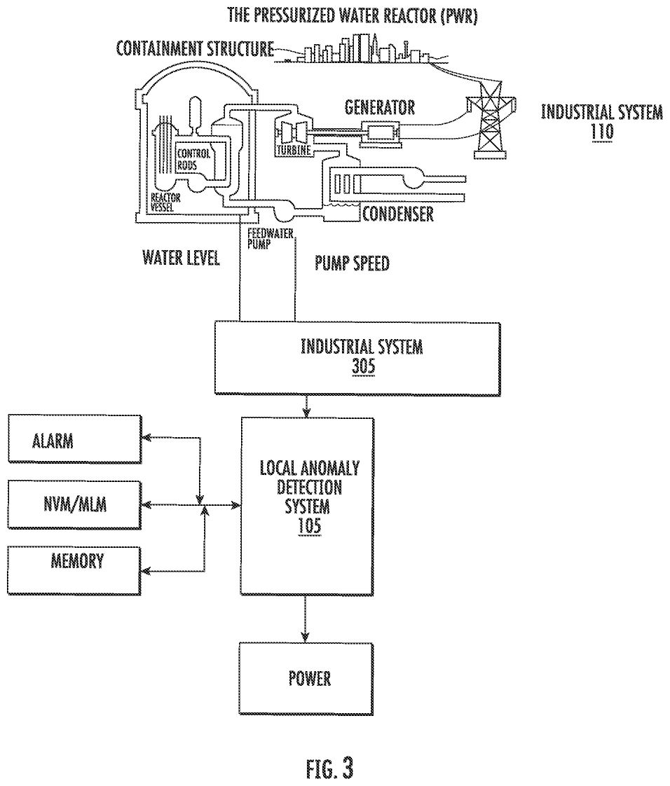

Some attempts have been made to detect attacks early using simple thresholding. FIG. 2 is a graphical illustration of such a simple threshold detection approach for normal operational ranges of system parameters for operation of an example industrial system. According to FIG. 2, x1, x2, and x3 are three parameters in a hypothetical process. For each parameter, the normal operating range is shown with the solid black line defining cuboid 205. If a threshold for each parameter is used, when the value is outside of the range, the alarm will be triggered. Therefore, the thresholds for all three parameters form a cuboid 205 in 3 dimensions. However, actual operations are shown by the cloud of operating points 210, which is a subset of the cuboid 205. When the operations of the process fall outside the operating points 210 as indicated by points 215, the values for the parameters would not trigger any alarm as points 215 are inside in the cuboid 205.

FIG. 3 is a block diagram illustrating nuclear power plant 300 including a steam generator system as an example of an industrial system 305 operatively coupled to a local anomaly detection system 105 configured to detect anomalous operation of the industrial system 305 in some embodiments according to the invention. According to FIG. 3, the industrial system 305 is configured to control the steam generation process using process parameters such as the water level and the pump speed. For example, in normal operation the industrial system 305 is configured to maintain the water level in a nominal range as the output of the NPP varies. As the water level drops (resulting from increased heat/steam generation) the industrial system 305 can increase the pump speed to keep the water level within range. Conversely, when the output of the NPP is reduced, less heat/steam may be generated whereupon the industrial system 305 may decrease the pump speed to also keep the water level within range.

It will be understood that as used herein, the industrial system 305 can operate using process parameters that include two types: control sensors and indications sensors. In operation, these process parameters are provided to the industrial system 305 as having particular values. In particular, the control sensors can indicated a measurement in the system but are also used to control some portion of the system. For example, the water level described above is a measurement of the water level but is also the subject of control by the operation of the industrial system 305. In other words, the industrial system 305 is configured to control the water level in the steam generator based on the other process parameters monitored by the system including the indication of the water level. Moreover, the control sensor can be a critical one of the process parameters monitored by the industrial system 305 as the value provided by the control sensor may be more likely to be the target of an attack or indicative of anomalous operation. Accordingly, some control sensors may be subject to more security that other control sensors or sensors. In contrast to the control sensors, the indication sensors can relate to provide a measurement within the system, but are not the parameter that the industrial system 305 is configured to control. Accordingly, the pump speed described above is an example of an indication sensors for the industrial system 305.

Still referring to FIG. 3, the local anomaly detection system 105 receives operating values of the operating parameters for the process controlled by the industrial system 305. In operation, the local anomaly detection system 105 can includes a machine learning model MLM that is stored locally in a non-volatile memory NVM. The local anomaly detection system 105 can also include a working memory that can be used to operate on the operating values of the process parameters to determine predicted values for the process parameters based on the operating values using the MLM.

Further, in some embodiments the local anomaly detection system 105 is configured to determine a difference between the predicted values and the operating values to provide respective residual values which can be compared to threshold values. Based on the differences, an ALARM can be generated by the local anomaly detection system 105 can includes in some embodiments. In some embodiments according to the invention, different the alarms can be generated for different the residual values as compared to the respective threshold value. For example, alarms for different process parameter values can be generated using different thresholds.

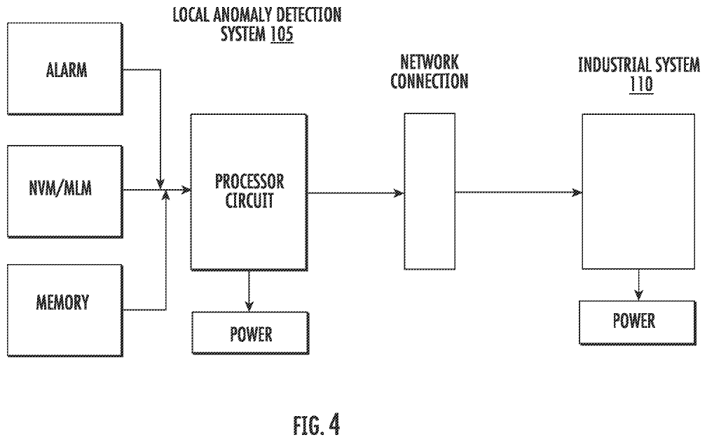

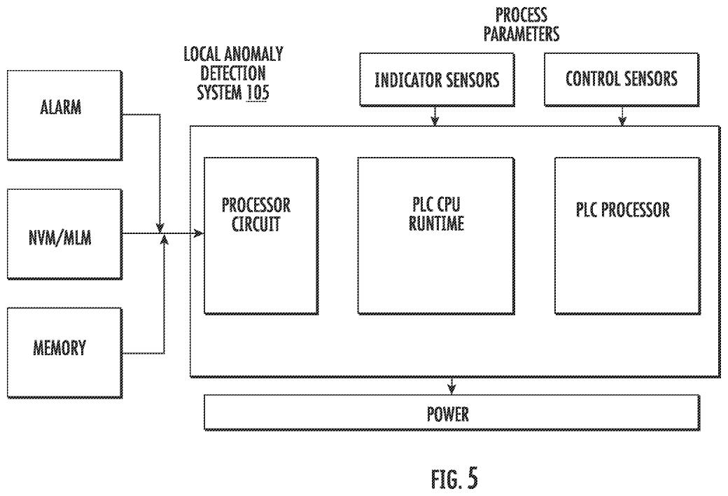

FIG. 4 is a block diagram illustrating an industrial system 110 coupled to a separate local anomaly detection system 105 configured to monitor the industrial system 110 in some embodiments according to the invention. According to FIG. 4, the local anomaly detection system 105 can be a small low-power independent processing system that is operatively coupled to the industrial system 110. For example, in some embodiments the local anomaly detection system 105 can have a power source that is independent of the power source for the industrial system 305. Still further the processor circuit in the local anomaly detection system 105 can be separate from a processor that operates the industrial system 110 to control the process.

In other embodiments according to the invention, the local anomaly detection system 105 can be provided by a small processing system including a Raspberry Pi microcontroller having the capability to interface to the industrial system 110 to receive and operate on the process parameter data by accessing the NVM storing the MLM as described herein. The NVM may be a semiconductor NVM that maintains data stored there when power to the NVM is removed such that when the local anomaly detection system 105 is powered off the MLM stored therein is maintained such that when the local anomaly detection system 105 is powered on, the MLM is available to the local anomaly detection system 105 without requiring access to a system outside the local anomaly detection system 105. In some embodiments, the MLM used to process the process parameters can be stored entirely in the NVM.

The MLM can be any MLM that can be stored in the NVM and used to operate on the process parameters without supervision and without requiring additional hardware support. For example, in some embodiments the MLM can be based on an Auto-Associative Kernel Regression (AAKR). As appreciated by the present inventor, the AAKR can provide several advantages including that it is a non-parametric method, which requires no detailed knowledge of the control being protected, the simplicity of the algorithm enables it to run on low-memory devices, and is an unsupervised learning algorithm, in which the normal model is built through collecting data during normal operation and any deviation from this operation can be detected, including faults never seen before or zero-day attacks. Since many cyber-attacks aim to cause process changes by modifying the control logic, modifying the inputs of the controller, and modifying the control command of the controller, AAKR can monitor the relationship among the process variables and detect deviations from normal operation to cover all types of the cyber-attacks that can be evidenced by a process anomaly.

In some embodiments, the AAKR model can be pre-trained and then stored in the NVM. For training, a memory matrix Xₘ is a reasonably-sized matrix selected from the normalized historical normal operation conditions (training data) to present the range of normal operations as shown in Eq. (1):

$${X}_{m} = [ \begin{matrix}\begin{matrix}\begin{matrix}\begin{matrix}\begin{matrix}\begin{matrix}\begin{matrix}{X}_{1} \\ {X}_{2}\end{matrix} \\ ⋮\end{matrix} \\ {X}_{i}\end{matrix} \\ ⋮\end{matrix} \\ {X}_{j}\end{matrix} \\ ⋮\end{matrix} \\ {X}_{n}\end{matrix} ] = [ \begin{matrix}{x}_{11} & {x}_{12} & … & {x}_{1 m} \\ {x}_{21} & {x}_{22} & … & {x}_{2 m} \\ ⋮ & ⋮ & ⋱ & ⋮ \\ {x}_{i 1} & {x}_{i 2} & … & {x}_{im} \\ ⋮ & ⋮ & ⋱ & ⋮ \\ {x}_{j 1} & {x}_{j 2} & … & {x}_{jm} \\ ⋮ & ⋮ & ⋱ & ⋮ \\ {x}_{n 1} & {x}_{n 2} & … & {x}_{nm}\end{matrix} ] , \qquad ( 1 )$$

where m is the total number of the state variables being monitored by the industrial system 305, n is the total number of records of the memory matrix, and xij is the i^{th} variable in the i^{th} memory vector Xi. For industrial processes, there are usually limited and stable normal operation conditions due to the nature of the process. For example, if a process has three normal operational conditions, then X1 to Xi may represent the first set of operating conditions, Xi to Xj will represent the second set of operating conditions and Xj to Xₙ will represent the third set of operating conditions. A new measurement of these n state variables, denoted as a vector Q(1,m) is structured as:

Q=[q₁,q₂, . . . ,qₘ] (2)

When this vector is acquired by the AAKR model, it is normalized first and then the similarities between the vector Q and the memory vectors are calculated via Euclidean distance, denoted by di as shown in Eq. (3):

\sqrt{dᵢ=(xᵢ₁−q₁)²+(xᵢ₂−q₂)²+ . . . +(xᵢₘ−qₘ)²}. (3)

Then the weight of each memory vector denoted by Wi is obtained by a Gaussian kernel function with bandwidth h as shown in Eq. (4):

$${w}_{i} = \frac{1}{\sqrt{2 π {h}^{2}}} exp ( - \frac{{d}_{i}^{2}}{{h}^{2}} ) . \qquad ( 4 )$$

The predicted values as denoted by P=[P1, P2, . . . , Pₘ] is calculated by a weighted average of the memory vectors, as shown in Eq. (5):

$$P = \frac{{\sum }_{i = 1}^{n} {w}_{i} {X}_{i}}{{\sum }_{i = 1}^{n} {w}_{i}} . \qquad ( 5 )$$

Then the residuals denoted as R=[r1, r2, . . . , rₘ] are obtained by:

[r₁,r₂, . . . ,rₘ]=[p₁,p₂, . . . ,pₘ]−[q₁,q₂, . . . qₘ]. (6)

Thresholds for each state variables, denoted by Tr=[tr1, tr2, . . . , trₘ], can be engineered by setting a value that generates an acceptable false alarms rate under the normal conditions. The alarm vector is then computed as a series of truth values:

A=[a₁,a₂, . . . ,aₘ], aᵢ=(rᵢ>tᵢ), i∈[1,m]. (7)

It will be understood that, depending on application, the industrial system 305 may then be alerted if one or more elements of the alarm vector is true; for some applications only one alarm may be required to raise an alert, while for others multiple alarms may be required.

It will be further understood that other MLM may also be used in some embodiments according to the invention. For example, the MLM may be implemented using, for example, artificial or deep neural networks, decision trees, K nearest neighbor, ensemble learning, bagging, random forest and the like. Other approaches may also be used separately or in combination with those listed.

Still further in some embodiments according to the present invention, a plurality of MLM may be used to provide a plurality of determinations as to whether an anomaly or attack is present. The determination may be made by a majority rule, a weighted combination of the plurality of determinations, or the like.

FIG. 5 is a block diagram illustrating a Siemens S7-1518 MFP PLC programmable logic controller (PLC) environment that was implemented to provide a CPU runtime environment to operate an industrial system using process parameters of the process controlled by the industrial system being monitored for anomalous operation by the local anomaly detection system 105 implemented using the PLC system in some embodiments according to the invention. FIG. 5 shows the structure of a Siemens S7-1518 MFP PLC and the local anomaly detection system 105 implemented using the S71518 MFP PLC. The Siemens S7-1518 MFP PLC provides a CPU runtime for the control logic programming and execution. The control logic is executed using organisation blocks (OB) which can be programmed in several different PLC programming languages. One widely used language called ladder logic was utilized to program the control logic through the Siemens Totally Integrated Automation (TIA) Portal.

Data blocks are blocks also provided in the CPU runtime to create and store the parameters utilized in OBs. The parameters can be programmed to be written in a csv file for data collection. The Siemens S7-1518 MFP PLC also provides a C++ runtime as part of a custom Linux operating system, to allow for the implementation of algorithms and methods in C++. Open Development Kit (ODK) is an integrated development environment (IDE) to compile C++ code into binaries for running on this C++ runtime. It provides Target Communication Framework (TCF) to enable the code transfer through Secure Shell (SSH). An SSH client (PuTTY) was utilized to transfer a pre-trained AAKR model while WinSCP, a File Transfer Protocol (FTP) client, was utilized to transfer data to the Linux component.

The C++ runtime can access data blocks in the CPU runtime with read and write rights through OPC UA server and client set up in the local anomaly detection system 105. This sets up the CPU runtime as an OPC server and the C++ runtime as an OPC client. After the initial transfer to the C++ runtime, the local anomaly detection system 105 operates on the PLC to read the operating values of the process parameters from the data block in real time, access the MLM to generate the predicted values of the process parameters and generate residuals values and alarms which can be sent to the CPU runtime to alert the controller, or output to an external device such as an engineering workstation to alert the operators in some embodiments.

Although some embodiments according to the present invention describe the local anomaly detection system 105 as operating in a Siemens S7-1518 MFP PLC environment, it will be understood that embodiments according to the present invention can operate in an PLC environment what allows real-time access to the process parameters without impacting the operation of the PLC to the point where control of the industrial system being monitored cannot be maintained.

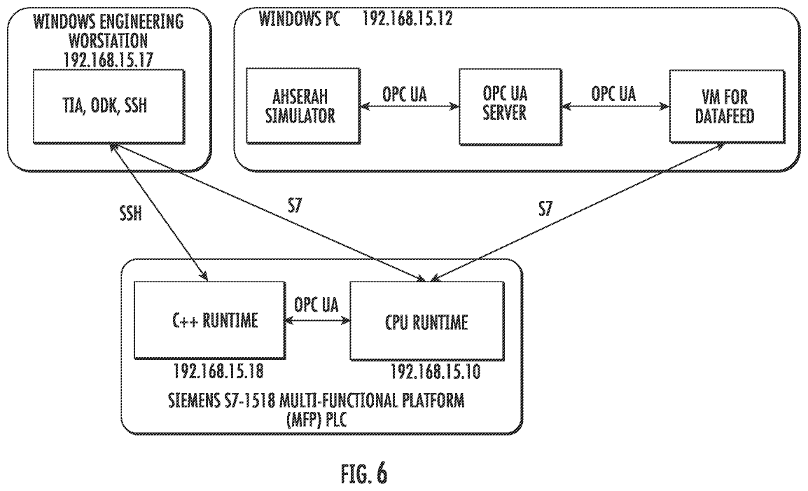

FIG. 6 is a schematic illustration of a testbed used to evaluate the local anomaly detection system shown in FIG. 5 in some embodiments according to the invention. As shown in FIG. 6, the testbed included three hosts: a Windows engineering workstation, a Windows computer, and a Siemens S7-1518 MFP PLC. The Windows engineering station contained a TIA portal to program the PLC CPU Runtime, an ODK to program the C++ runtime, and software for SSH to transfer the C++ code and other files (such as the memory matrix) to C++ runtime as described herein. The Windows PC contained an Asherah nuclear power system simulator, an OPC UA server, and a DataFeed on a windows virtual machine.

Asherah is a MATLAB Simulink based pressurized water reactor (PWR) simulator that is designed for cybersecurity HIL research. The Asherah simulation has been run against the well-known neutronics code PARCS-3D, and thermal-hydraulic system code RELAP5; both codes are well-known codes used by the United States Nuclear Regulatory Commission (NRC) for reactor analysis. To enable communication with the hardware, Asherah has an Open Platform Communications (OPC) read/write module which allows the simulator to transfer parameters with an external data source through the OPC Unified Architecture (UA) protocol. Therefore, a Prosys OPC UA server was utilized to connect with MATLAB Simulink and to a Softing dataFEED OPC Suite as shown in FIG. 6. DataFEED can read/write the data from leading manufacturers' controllers without modifying control programs, and is utilized to communicate with the OPC UA server via the OPC UA protocol and the Siemens PLC via the S7 protocol to achieve data exchange between the PLC and Asherah.

Referring to the layout of the NPP shown in FIG. 3, a PWR is a type of nuclear reactor that includes a primary loop and secondary loop. The primary loop mainly consists of the reactor core where the fission reaction takes place and generates heat, the main coolant pump to force coolant water to circulate through the reactor core, the steam generator (SG) primary side, and the pressurizer to maintain pressure in the closed loop. The Reactor Cooling System (RCS) in the primary loop, is the system that takes the heat from reactor core and transfers it to the secondary side through the steam generator without leak of radioactive materials. The coolant water in the primary side is radioactive since it contacts fission products in the core directly.

The secondary loop of the NPP includes the steam generator (SG) secondary side, turbines, condenser, and feedwater pump. The feedwater pump forces cold water from the condenser into the SG to be heated to steam by drawing heat from primary side. The steam produced in the SG then goes to different turbines to generate electricity. The exhausted steam is then condensed into water in the condenser and pumped back to the SG by the feedwater pump. The water and steam in the secondary side is not radioactive so that the turbine can be located outside the containment structure, which is utilized for shielding.

The steam generator, a heat exchanger between the primary loop and the secondary loop, can be considered key equipment in an NPP for both steam generation and serving as part of the radioactive material boundary. 3,000 to 16,000 u-shape tubes are located in the bottom to perform heat transfer. Two level separators located in the top of the SG separate the steam and water to provide close-to-dry steam to the turbines, since the moisture in the steam could reduce the performance of the turbine and accelerate the degradation/failure of the turbines.

Given that both water and steam are present in the steam generator the control of the water level in the SG is crucial for the safe operation of an NPP. If the water level is higher than the desired range, the water can overflow the separator; and if the water level is lower than the desired range, the heat transfer tubes will be partially exposed and may start breaking due to high thermal stress caused by unevenly heated tubes. If the percentage of breaking tubes reach a certain level, the reactor could trip or radioactive coolant could be release to environment. Accordingly, the evaluation performed utilized a PLC to control the SG water level, to mimic the important functions that PLCs often related to command and control in industry applications.

The PLC CPU runtime is programmed with ladder logic to perform this SG water level control. It takes the SG water level measurement SG Level from dataFeed, which is transferred from the Prosys OPC UA server and updated by the Asherah simulation. A Proportional Integral Derivative (PID) controller is widely utilized in industry for set point control, which can automatically adjust the control output based on the difference between a set point and the measured value of a process variable. In the PLC ladder logic, a PID module is used to take the SG Level in and output the feedwater pump speed command PLCspeedcmd according to the set point of SG water level, which is 15 meters (m) in Asherah.

In normal operation, the feedwater pump speed is maintained at about 50% of the maximum speed, so it can increase or decrease accordingly to maintain the desired water level. The PLCspeedcmd is fed back to dataFeed and then to the Prosys OPC UA server and to Asherah, which updates the whole system simulation accordingly. Therefore, a fully closed-loop HIL testbed was achieved to test the hardware in-situ and monitor the entire system via simulation. The update frequency of all the data transfer was set to at least 1 HZ.

Only one parameter SG Level was needed for the control. However, in some embodiments according to the invention, a PLC may receive several parameters to control a system; for example, the SG water level control in a real NPP may involve reactor power, turbine first stage pressure, SG outlet steam flow rate, SG inlet feedwater flow rate, SG pressure, and other process parameters. Therefore, other than SG Level, reactor power RX Power, SG inlet feedwater flow rate SG InletFlow, and SG pressure SG Press were also fed into the PLC to simulate PLC access to several process variables to evaluate the local anomaly detection system.

All the parameters utilized in the PLC were created and stored in the data blocks. The version of Asherah utilized in this study simulated the normal operation of reactor power from 80% to 100% nominal power. Therefore, the values of these five process variables under a normal transient operation from 100% to 80% nominal power were collected to generate the memory matrix.

To evaluate the simulated environment shown in FIG. 6, two different types of attacks were simulated: 1) a MITM attack to alter the PLC inputs and 2) modifying the ladder logic in the PLC. In scenario 1) the attacker overwrites the input of the PLC via MITM attack. In scenario 2), the attacker alters the PLC control logic by displaying the correct logic to the operator utilizing stealth program injection. In this scenario, the PLC logic is being modified to add an additional value to the SG level measurement sent to the PLC, effectively causing the PLC to run with different logic from the control logic displayed to the operators. In both simulated scenarios, the PLC operates with the original correct logic (normal operation) in the first 100 seconds. After 100 s, in Scenario 1) the SG Level value was overwritten to 14.5 m by MITM attack (3.33% away from set point), and in Scenario 2) 0.5 m was added to the SG Level value by malicious logic injection.

In scenario 1) given that the PID controller in the PLC always has a positive difference between the set point and the measured value SG Level, it outputs a higher than 50% PLCspeedcmd to try to bring the SG Level to the set point 15 m. In scenario 2) the PID controller in the PLC has a negative difference between the set point and the measured value in the beginning and outputs a lower than 50% PLCspeedcmd to bring the received SG Level to the set point 15 m, which in reality sets the water level to be 14.5 m consistently.

Data from normal operational transients from 100% to 80% of nominal power were collected to insure that the HIL produced satisfying normal operational data. Then the data set was divided into 70% training and 30% test data by Venetian Blinds method to insure that the different process states were represented in both training and test data set. Both data set were normalized to make each state variable have the same weight. The AAKR model contained five variables that were selected based on the variable availability in Asherah and engineering judgement of the system including: reactor power, feedwater pump speed command PLCspeedcmd,SG inlet flow rate SG InletFlow, SG pressure SG Press, and SG water level SG Level. A grid search to find the optimized combination number of memory matrix and the bandwidth was conducted on the test data. The model producing the lowest root mean square error (RMSE) as shown in equation 8 was selected as the best model to implemented in the PLC:

$$RMSE = \sqrt{\frac{1}{n \text{?}} {\sum }_{i = 1}^{n \text{?}} {[ p {\text{?}}_{i , k} - q {\text{?}}_{i , k} ]}^{2} ,} \qquad ( 8 )$$

$$\text{?} \text{indicates text missing or illegible when filed}$$

Where p \tilde{ }i,k is the i^{th} observation's expected value of the kth feature by AAKR, —˜qi,k is the i^{th} observation's real measurement of the k^{th} feature (k=5 in this case), and nt is the total number of observations of the test data set. The trained model was then transferred to the C++ runtime; together with the required OPC UA communication setup between the CPU and C++ runtimes. Once a new observation of the process variables Q was queried, it was first normalized and then passed through the AAKR model to generate the predicted values and alarms.

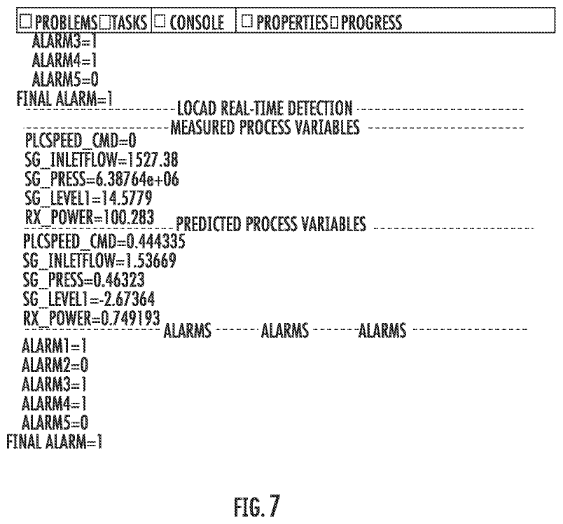

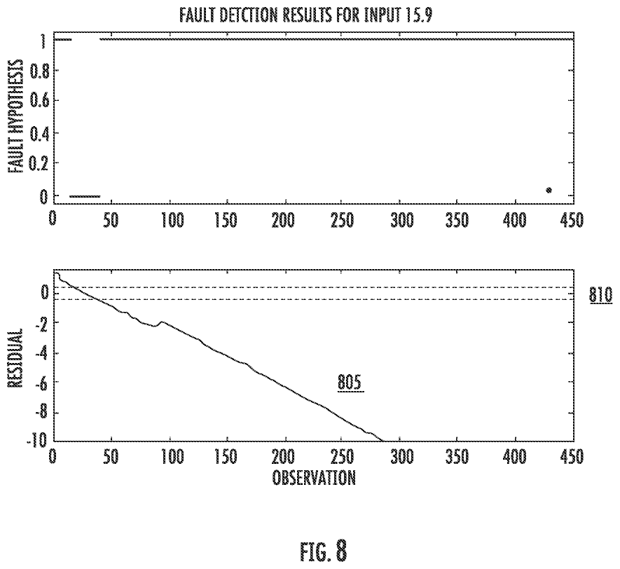

ODK was utilized to display the real-time detection results as shown in FIG. 7, which prints out the values of the measured process variables, their normalized predicted values, alarms (“1” means a fault is detected while “0” means the process variables are normal), and the final alarm state where two or more alarms in these five variables give an alert. In both attack scenarios, after 100 s of normal operation, the alarm in the ODK print-out become 1. The alarms and the predicted values are also written into a file which can be sent to the external devices for alarm alert and further analysis. The alarms of both scenarios remain at 1 after 100 s. The update frequency of the PLC control output remains same with or without running the C++ runtime for detection. This indicates that the real-time detection does not impact the intended PLC control logic.

Three additional attack scenario evaluations were performed using the test setup shown in FIG. 6 using three malware programs that alter the SG water level measurement so that the PLC receives a compromised water level value as a process parameter. In scenario I), PI controller input in the PLC was compromised with constant values by the malicious code. This was conducted by overwriting SG level measurement to 15.9 m constantly in PLC. This made the PLC controller issue commands based on the false value irrespective of how the process changed. The pump speed was kept in the lowest value until the SG ran dry and the simulation crashed. In scenario II) the malicious code added 0.9 m to the actual SG water level measurement at the input of the PLC, which altered the input of the PLC controller to X+0.9 m (X being the actual SG water level measurement). In this situation, the PLC reduced the pump speed until the actual SG water level reached 14.1 m. Meanwhile, the malicious program masked the malicious action by providing a false reading of 15 m to the operator. In scenario III) the malicious program altered the SG water level set point in the PLC to 14 m and masked it as well. The PLC reduced the pump speed and kept low pump speed until the SG water level reduced to 14 m, which matched the altered set point.

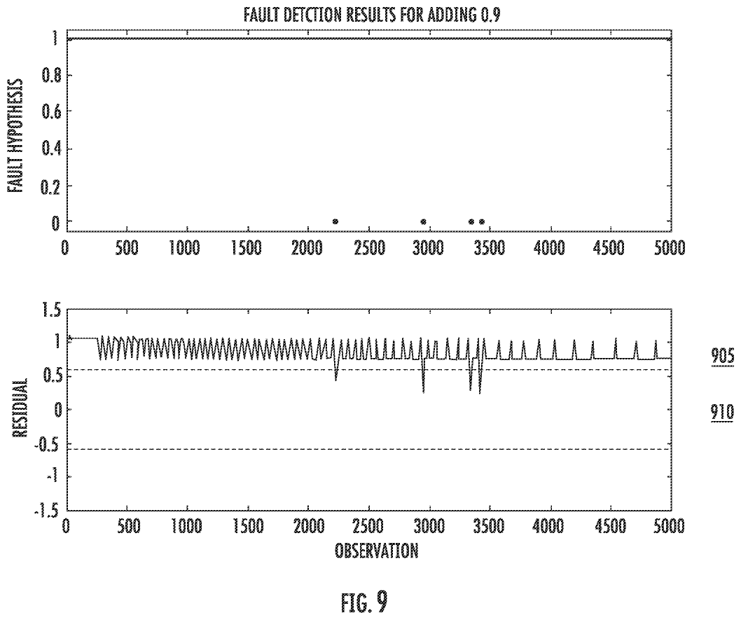

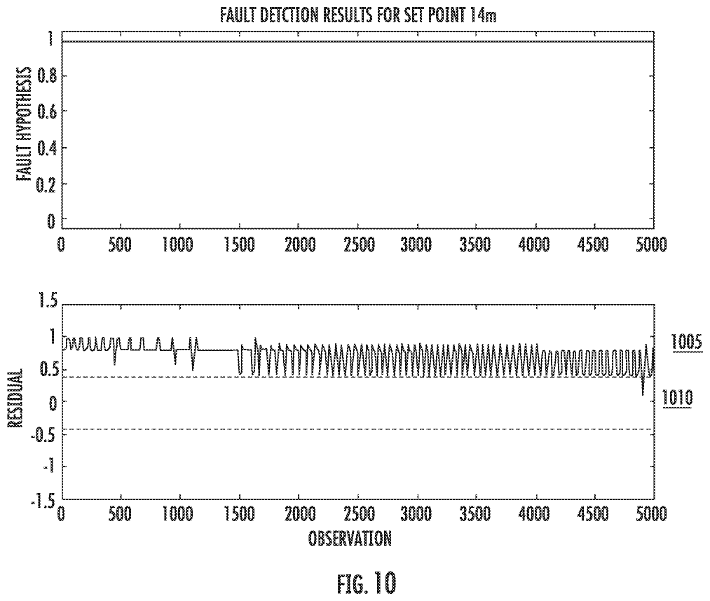

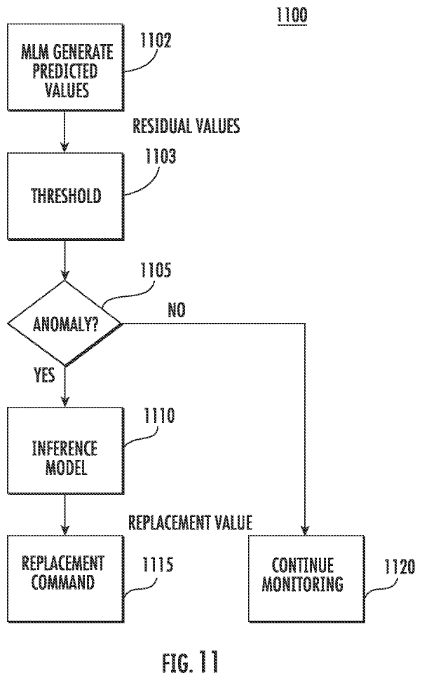

FIGS. 8, 9, and 10 are graphs showing the fault detection results by AAKR model in scenarios I, II, and III, respectively. In particular, FIG. 8 shows steam generator pressure data for the local anomaly detection system shown in FIG. 5 in an attack scenario where the water level of the steam generator as a measurement input to the PLC was altered to 15.9 m constantly but having the water level values shown to the operator as normal (15 m) in some embodiments according to the invention. FIG. 9 shows steam generator inlet flow rate data for the local anomaly detection system shown in FIG. 5, where malicious code added 0.9 m to the actual steam generator water level measurement at the input of the PLC, which alters the input of the PI controller to X+0.9 m (X being the actual SG water level measurement) in some embodiments according to the invention. FIG. 10 shows steam generator water level data for the local anomaly detection system shown in FIG. 5, where malicious code altered the water level set point to the PLC to 14 m which was also masked in some embodiments according to the invention.

In each of the FIGS. 8-10, the bottom subplot shows the residual value of a signal 805, 905, and 1005 respectively and the corresponding thresholds 810, 910, and 1010 respectively; the respective upper subplot shows the fault hypothesis based on the residual and the thresholds relationship. When the residual exceeds the threshold, the fault hypothesis is “1” and indicates a fault state while “0” means the residual is within the threshold and indicates a normal state. Threshold values for different variables were selected separately and the final alarms were the combination of alarms. In these evaluations, thresholds were engineered for three different signals SG inlet flow rate, SG level, and SG pressure since these signals give clear indications of the operation change. For clarity, only SG pressure is shown in FIG. 8, SG inlet flow rate is shown in FIG. 9, and SG water level is shown in FIG. 10. As shown, the anomaly in these three scenarios are detected effectively by the local anomaly detection system of FIG. 6.

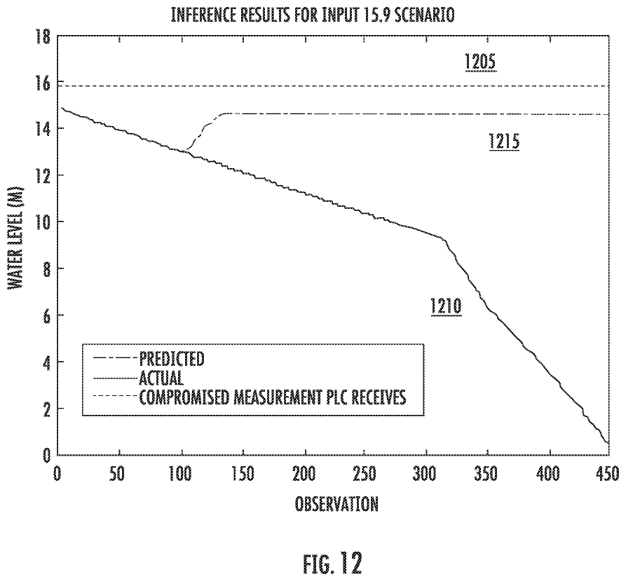

In still other embodiments according to the invention, the local anomaly detection system can intervene in the control provided by the industrial system in response to detecting an anomaly or an attack. FIG. 11 is a flowchart illustrating operations 1100 of the local anomaly detection system configured to detect anomalous operation of, or attack on, an industrial system using a machine learning model implemented using an auto-associative kernel regression approach to raise an alarm and to alternatively intervene in the control of the industrial system being monitored by generating a replacement command using an inference model based on the predicted values provided by the machine learning model in some embodiments according to the invention. According to FIG. 11, operational values for the process parameters are applied to the MLM (block 1102) to generate predicted values for the process parameters, the difference of which is used to provide the residual values. The residual values are compared to respective threshold values, the difference of which is compared to respective threshold values (block 1103) the difference of which is used to detect whether an anomaly or attack is present (block 1105). If not anomaly or attack is detected then monitoring continues (block 1120). If, however, an anomaly or attack is present (block 1105) then an inference model can be used to generate a replacement value (block 1110) for the process parameter that was determined to be anomalous (block 1105). In some embodiments according to the invention, the replacement value can be generated by applying the predicted values provided by the MLM to the inference model. In some embodiments the inference model can be an SVR model. The inference model can provide an inferred value which can then be mapped to a replacement command for the industrial system (block 1115). In some embodiments according to the invention, the replacement command can be a command configured to place the industrial system in a known stable condition.

In some embodiments according to the invention, the SVR model can be based on support vector machine (SVM) theory. The SVR of any variable can be expressed as:

$$\hat{{y}_{i}} = {f}_{i} ( x ) = ϕ ( {x}_{i} ) {w}_{i} + {b}_{i} = {\sum }_{i = 1}^{n} {y}_{i} {α}_{i} ϕ ( {x}_{i} ) \cdot ϕ ( {x}_{i} ) + {b}_{i} , \qquad 9$$

where the vector wi is the weight, bi is the bias, f(xi) is the support vector, n is the number of total observations, yi and y\hat{ }i are the regression target and the predicted value of the regression, respectively, and ai is the coefficient for the weight. The objective function of SVR is shown as:

$$U {\sum }_{i = 1}^{n} L [ {y}_{i} - \hat{{y}_{i}} ] + {‖ w ‖}^{2} . \qquad 10$$

The first part and second parts of the equation measure error and generality, respectively. U is a user-defined parameter to adjust the objective function. Large U makes the objective function put more emphasis on the error while small U puts more emphasis on the norm of the weights which yields a more general regression. L is a ǫ-insensitive loss, which is defined as:

$$L = \{ \begin{matrix}0 , & \vert {y}_{i} - \hat{{y}_{i}} \vert < ϵ \\ \vert {y}_{i} - \hat{{y}_{i}} \vert - ϵ \text{?} & otherwise\end{matrix} , \qquad 11$$

$$\text{?} \text{indicates text missing or illegible when filed}$$

where ǫ is a user-defined insensitive margin. The figure below shows the parameters for SVR, where xi and xⱼ* are the difference between observed points and the values on ǫ band. If the observed point is inside the 2ǫ band, xi and xⱼ*are zero which makes ai zero. If the observed point is outside the ǫ bands, then xi and xⱼ* are nonzero and ai is nonzero. Therefore, the observed points within the ǫ and have no impact on the regression equation fi(x). This means only a subset of the training data are utilized for prediction, which are called the support vectors since they support the regression function.

Therefore, minimizing Eq. (10) is equivalent to minimizing the following equation:

$$U ( {\sum }_{i = 1}^{n} {ξ}_{i} + {\sum }_{i = 1}^{n} {ξ}_{j}^{⋆} ) + \frac{1}{2} ( {w}^{t} w ) \qquad 12$$

for all i=1, 2, . . . , n. The constraints are shown as follows:

$$\{ \begin{matrix}{y}_{i} - ( {w}^{t} ϕ ( x ) + b ) \leq ϵ + {ξ}_{i} & ϵ \text{?} {ξ}_{i} , {ξ}_{i}^{⋆} \geq 0 \\ {w}^{t} ϕ ( x ) + b - {y}_{i} \leq ϵ + {ξ}_{i}^{⋆} & ϵ \text{?} {ξ}_{i} , {ξ}_{i}^{⋆} \geq 0\end{matrix} . \qquad 13$$

$$\text{?} \text{indicates text missing or illegible when filed}$$

In Eq. (9), yif(x) is a dot product of a new observation and support vector, which could be written as a more general equation as:

$$f ( q ) = {b}_{i} + {\sum }_{i = 1}^{n} {α}_{i} K ( {x}_{i} , q ) , \qquad 14$$

where xi is the element of inputs in the model, q is the new query observation, and K(xi, u) is called the kernel function. There are different types of kernel functions that can be used to generalize the regression with nonlinear relationships. Radial basis function (RBF) as shown in Eq. (15) is a Gaussian kernel with a scaling parameter s.

exp(−σ∥x−q∥²) 15

The approach described above regarding the inference model was also tested using the configuration shown in FIG. 6 and the data collected is presented in FIG. 12. FIG. 12 shows steam generator water level data including compromised water level, actual water level extracted from the Asherah model. In particular, once an anomaly was detected, the control variable measurement was assumed to be compromised and was no longer trusted to control the industrial system. In some embodiments according to the invention, the inference model was used to generate a replacement value as the actual measurement as a virtual sensor. Theoretically, SG water level may be inferred from SG-related variables by a pre-trained regression model, such as SG inlet flow, SG pressure, and SG related temperature values. Thus, in this testbed, the SVR model used the PLC speed command, reactor power and SG pressure to predict the real SG water level. The variable selection was based on variable availability in the Asherah SIMULINK model and the relationship between variables.

In scenario I, the water level measurement input to the PLC was altered to 15.9 m constantly but the values shown to the operator were a “normal” 15 m display. FIG. 12 shows the compromised water level, real water level extracted from the Asherah model, and inference results. The line 1205 shows a constant value of 15.9 m which is a compromised measurement that the PLC received. As the PLC received a positive difference between water level measurement and the reference level, it maintained a low feedwater pump speed to bring down the water level measurement. However, the actual water level was further reduces as shown by the line 1210, until the SG ran dry in this testbed because the PLC constantly received 15.9 m as input. Under this advanced attack scenario, once the fault was detected in the beginning of the attack as shown in FIG. 8, the control sensor SG water level could no longer be trusted. Then the inference value from the inference model could be utilized as a virtual sensor. The line 1215 in FIG. 12 shows the predicted value by the inference model. This gives the correct prediction during the first 100 observations when the SG water level drops from 15 m to about 13 m.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element is referred to as being “connected” or “coupled” to another element, it can be directly connected or coupled to the other element or intervening elements may be present. In contrast, if an element is referred to as being “directly connected” or “directly coupled” to another element, there are no intervening elements present. It will be understood that, although the terms first, second, etc. may be used herein to describe various elements, these elements should not be limited by these terms. These terms are only used to distinguish one element from another. Thus, a first element could be termed a second element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will further be appreciated by one of skill in the art, the present invention may be embodied as methods, systems, and/or computer program products. Accordingly, the present invention may take the form of an entirely hardware embodiment, an entirely software embodiment or an embodiment combining software and hardware aspects. Furthermore, the present invention may take the form of a computer program product on a computer-usable storage medium having computer-usable program code embodied in the medium. Any suitable computer readable medium may be utilized including hard disks, CD-ROMs, optical storage devices, or magnetic storage devices.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The invention is also described using flowchart illustrations and block diagrams. It will be understood that each block (of the flowcharts and block diagrams), and combinations of blocks, can be implemented by computer program instructions. These program instructions may be provided to a processor circuit, such as a microprocessor, microcontroller or other processor, such that the instructions which execute on the processor(s) create means for implementing the functions specified in the block or blocks. The computer program instructions may be executed by the processor(s) to cause a series of operational steps to be performed by the processor(s) to produce a computer implemented process such that the instructions which execute on the processor(s) provide steps for implementing the functions specified in the block or blocks. Accordingly, the blocks support combinations of means for performing the specified functions, combinations of steps for performing the specified functions and program instruction means for performing the specified functions. It will also be understood that each block, and combinations of blocks, can be implemented by special purpose hardware-based systems which perform the specified functions or steps, or combinations of special purpose hardware and computer instructions.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Computer program code or “code” for carrying out operations according to the present invention may be written in an object oriented programming language such as JAVA®, Smalltalk or C++, JavaScript, Visual Basic, TSQL, Perl, or in various other programming languages. Software embodiments of the present invention do not depend on implementation with a particular programming language. Portions of the code may execute entirely on one or more systems utilized by an intermediary server.

The code may execute entirely on one or more servers, or it may execute partly on a server and partly on a client within a client device or as a proxy server at an intermediate point in a communications network. In the latter scenario, the client device may be connected to a server over a LAN or a WAN (e.g., an intranet), or the connection may be made through the Internet (e.g., via an Internet Service Provider). It is understood that the present invention is not TCP/IP-specific or Internet-specific. The present invention may be embodied using various protocols over various types of computer networks.

It is understood that each block of the illustrations, and combinations of blocks in the illustrations can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the block and/or flowchart block or blocks.

These computer program instructions may be stored in a computer-readable memory that can direct a computer or other programmable data processing apparatus to function in a particular manner, such that the instructions stored in the computer-readable memory produce an article of manufacture including instruction means which implement the function specified in the block diagrams and/or flowchart block or blocks.

The computer program instructions may be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block diagrams and/or flowchart block or blocks.

Embodiments according to the invention can operate in a logically separated (or physically separated) client side/server side-computing environment, sometimes referred to hereinafter as a client/server environment. The client/server environment is a computational architecture that involves a client process (i.e., a client) requesting service from a server process (i.e., a server). In general, the client/server environment maintains a distinction between processes, although client and server processes may operate on different machines or on the same machine. Accordingly, the client and server sides of the client/server environment are referred to as being logically separated.

Usually, when client and server processes operate on separate devices, each device can be customized for the needs of the respective process. For example, a server process can “run on” a system having large amounts of memory and disk space, whereas the client process often “runs on” a system having a graphic user interface provided by high-end video cards and large-screen displays.

A client can be a program, such as a web browser, that requests information, such as web pages, from a server under the control of a user. An example of a client includes Internet Explorer® (Microsoft Corporation, Redmond, Wash.). Browsers typically provide a graphical user interface for retrieving and viewing web pages, web portals, applications, and other resources served by Web servers, A SOAP client can be used to request web services programmatically by a program in lieu of a web browser.

The applications provided by the service providers may execute on a server. The server can be a program that responds to the requests from the client. Some examples of servers are the Apache server and Microsoft's Internet Information Server (IIS) (Microsoft Corporation, Redmond, Wash.).

The clients and servers can communicate using a standard communications mode, such as Hypertext Transport Protocol (HTTP) and SOAP. According to the HTTP request-response communications model, HTTP requests are sent from the client to the server and HTTP responses are sent from the server to the client in response to an HTTP request. In operation, the server waits for a client to open a connection and to request information, such as a Web page. In response, the server sends a copy of the requested information to the client, closes the connection to the client, and waits for the next connection. It will be understood that the server can respond to requests from more than one client.

In the drawings and specification, there have been disclosed typical preferred embodiments of the inventive subject matter and, although specific terms are employed, they are used in a generic and descriptive sense only and not for purposes of limitation, the scope of the inventive subject matter being set forth in the following claims.

1. A method of detecting an operational anomaly of an industrial system, the method comprising:
receiving operational values for a plurality of process parameters from an industrial system at a localized anomaly detection system, wherein the plurality of process parameters;
accessing a machine learning model stored in a non-volatile memory system operating within the localized anomaly detection system, to determine predicted values for the process parameters based on the operational values of the process parameters received from the industrial system; and
determining residual values for the process parameters, each representing a difference between a respective one of the predicted values and a respective one of the operational values.

2. The method of claim 1 wherein the plurality of process parameters includes a process parameter that is subject to control by operation of the industrial system.

3. The method of claim 2 wherein the respective residual value represents a value of the process parameter that is subject to control.

4. The method of claim 2 wherein the process parameter that is subject to control is a critical one of the plurality of process parameters.

5. The method of claim 1 wherein the plurality of process parameters includes signals configured to control the process and sensors configured to indicate measurements associated with the process.

6. The method of claim 1 wherein the localized anomaly detection system is operationally coupled to the industrial system over a network connection. (spec)

7. The method of claim 1 wherein the industrial system is a single industrial sub-system included in a system including a plurality of industrial sub-systems and the localized anomaly detection system is configured to monitor the single industrial sub-system.

8. The method of claim 1 wherein the industrial system comprises a programmable logic controller (PLC) that provides a CPU runtime of the PLC including data blocks configured to store the plurality of process parameters.

9. The method of claim 8 wherein the localized anomaly detection system executes on a processor circuit included in the PLC.

10. The method of claim 8 wherein receiving the operational values for the plurality of process parameters further comprises:
transmitting a request for the operational values from a client on the localized anomaly detection system to a server on the CPU runtime of the PLC.

11. (canceled)

12. The method of claim 1 wherein the machine learning model stored in the non-volatile memory system comprises an auto-associative kernel regression machine learning model.

13. The method of claim 1 wherein the machine learning model stored in the non-volatile memory system comprises a machine learning model based on artificial or deep neural networks, decision trees, K nearest neighbor, ensemble learning, bagging, and/or random forest.

14.-15. (canceled)

16. A method of detecting an operational anomaly of a Programmable Logic Controller (PLC) system, the method comprising:
receiving, at a localized anomaly detection system, operational values for a plurality of process parameters from data blocks in a CPU runtime of the PLC system;
accessing a machine learning model stored in a non-volatile memory system operating within the localized anomaly detection system, to determine predicted values for the process parameters based on the operational values of the process parameters received from the PLC system; and
determining residual values for the process parameters, each representing a difference between a respective one of the predicted values and a respective one of the operational values.

17.-24. (canceled)

25. A localized anomaly detection system comprising:
a processor circuit configured to receive operational values for a plurality of process parameters from a single sub-system included in an industrial system, to monitor the single sub-system for anomalous activity;
a non-volatile memory storing a machine learning model configured to determine predicted values for the process parameters based on the operational values of the process parameters received from the single sub-system;
a memory operatively coupled to the processor circuit, the memory configured to store instructions to execute on the processor circuit to:
access the machine learning model stored in the non-volatile memory to determine the predicted values for the process parameters based on the operational values of the process parameters received from the single sub-system; and
determine residual values for the process parameters, each representing a difference between a respective one of the predicted values and a respective one of the operational values.

26. The system of claim 25 wherein the plurality of process parameters includes a process parameter that is subject to control by operation of the single sub-system.

27. The system of claim 25 wherein the process parameter that is subject to control is a highest security priority one of the plurality of process parameters.

28. The system of claim 25 wherein the single sub-system includes a PLC system and the processor circuit providing the localized anomaly detection system is located in the PLC system.

29. The system of claim 25 wherein the plurality of process parameters includes signals configured to control the process and sensors configured to indicate measurements associated with the process.

30. The system of claim 25 further comprising:
generating a respective alarm based on a comparison of a respective residual value to a respective threshold value for the residual value.

31. A method of detecting an operational anomaly of an industrial system, the method comprising:
receiving operational values for a plurality of process parameters from an industrial system at a localized anomaly detection system;
accessing a machine learning model stored in a non-volatile memory system operating within the localized anomaly detection system, to determine predicted values for the process parameters based on the operational values of the process parameters received from the industrial system;
determining residual values for the process parameters, each representing a difference between a respective one of the predicted values and a respective one of the operational values; and
generating a replacement command to the industrial system based on the predicted values responsive to a comparison of respective ones of the residual values to respective ones of threshold values for the residual values.

32. (canceled)
